(19) United States
(12) Patent Application Publication
(10) Pub. No.: US 2020/0097873 A1
(43) Pub. Date: Mar. 26, 2020

(54) INNOVATION SYSTEMS AND METHODS

(71) Applicant: salesforce.com, inc., San Francisco, CA (US)

(72) Inventors: Elizabeth DEGROOT, Westfield, IN (US); Eric LOPEZ, Portland, OR (US)

(73) Assignee: salesforce.com, inc., San Francisco, CA (US)

(21) Appl. No.: 16/141,177

(22) Filed: Sep. 25, 2018

(51) Int. Cl. G06Q 10/06; G06F 17/30

(52) U.S. Cl. CPC G06Q 10/06313; G06F 17/30312

(57) ABSTRACT

In one embodiment, a computer implemented system for managing development of an idea into an innovation is provided. The system includes: a user talent database that stores a plurality user talent profile records relating to user talent; an idea database that stores a plurality of idea records relating to an idea submitted by a user; and an innovation database that stores an innovation record that that is based on a defined process. The system further includes an innovation management module configured to manage the development of the idea into an innovation by populating the innovation record with an idea record of the plurality of idea records, populating the innovation record with a dynamic subset of the plurality of user talent profile records, and populating the innovation record with data input by one or more users.

### TECHNICAL FIELD

Embodiments of the subject matter described herein relate generally to methods and systems for managing development of ideas into innovations. More particularly, embodiments of the subject matter relate to computerized methods and systems for managing the collaboration of user talent when developing the innovations.

### BACKGROUND

Management systems have been developed to track the progress of problems reported in a system. In such systems, problems are reported and the solution is solved by an individual assigned to investigate the problem. Such systems are designed to solve problems and are not designed to develop new ideas.

Accordingly, it is desirable to provide methods and products for managing the development of a new idea into an innovation. It is further desirable to provide methods and systems that manage the collaboration of user talent when developing the innovation. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary innovation management system that may be implemented in the context of a computing environment, in accordance with various embodiments.

FIGS. 2, 3, 4A, 4B, 4C, 5, 6A, 6B, and 7 are illustrations of exemplary interfaces generated by the innovation management system, in accordance with various embodiments.

FIG. 8 is a data flow diagram of an innovation management module of the innovation management system, in accordance with various embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

The exemplary embodiments presented here relate to an innovation management system and related techniques, methodologies, procedures, and technology for managing innovations. The innovation management system can be a product itself that can be used by businesses or other entities when developing new ideas. As can be appreciated, the described subject matter can be implemented in the context of various environments. For exemplary purposes, the subject matter is described in the context of a computer-implemented environment relating to, for example, software products for a software-based system, a database system, a multi-tenant environment, or the like.

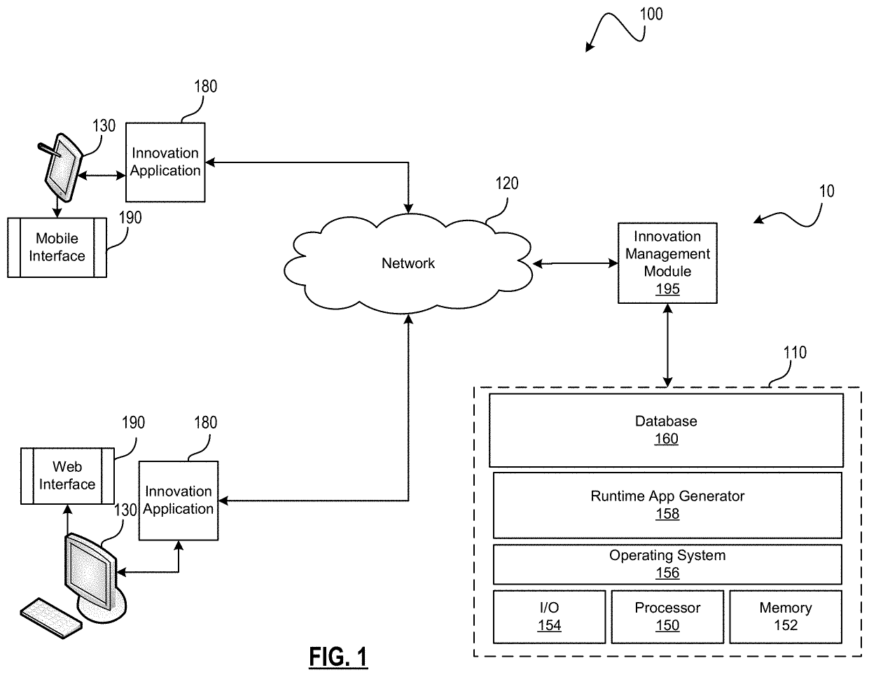

Turning now to the figures where an innovation management system 10 is shown and described in accordance with various embodiments. With reference to FIG. 1, in various embodiments, the exemplary innovation management system 10 may be implemented in the context of a computing environment 100. The computing environment 100 generally includes a computing system 110 communicatively coupled two one or more client devices 130 via a network 120. The computing system 110 can be any device having a processor and memory. In various embodiments, the computing system 110 can be a multi-tenant system. As can be appreciated, the innovation management system 10 may be implemented in other systems such as single tenant systems, personal computers, etc. and is not limited to the present example. For exemplary purposes, the innovation management system 10 will be discussed in the context of the multi-tenant system 110.

In various embodiments, the multi-tenant system 110 dynamically creates and supports virtual applications based upon data from a common database 160 that is shared between multiple tenants, alternatively referred to herein as a multi-tenant database 160. Data and services generated by the virtual applications are provided via the network 120 to any number of the client devices 130, as desired. Each virtual application is suitably generated at run-time (or on-demand) using a common application platform that securely provides access to data in the multi-tenant database 160 for each of the various tenants subscribing to the multi-tenant system 110.

As used herein, a “tenant” or an “organization” should be understood as referring to a group of one or more users or entities that shares access to common subset of the data within the multi-tenant database 160. In this regard, each tenant includes one or more users associated with, assigned to, or otherwise belonging to that respective tenant. To put it another way, each respective user within the multi-tenant system 110 is associated with, assigned to, or otherwise belongs to a tenant of the plurality of tenants supported by the multi-tenant system 110. Tenants may represent employees, customers, business or legal organizations, and/or any other entities that maintain data for sets of users within the multi-tenant system 110 (i.e., in the multi-tenant database 160). Although multiple tenants may share access to the multi-tenant system 110, the data and services provided from the multi-tenant system 110 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data belonging to or otherwise associated with other tenants.

In various embodiments, the multi-tenant system 110 is implemented using one or more actual and/or virtual computing systems that collectively provide a dynamic application platform for generating the virtual applications. For example, the multi-tenant system 110 may be implemented using a cluster of actual and/or virtual servers operating in conjunction with each other, typically in association with conventional network communications, cluster management, load balancing and other features as appropriate. The multi-tenant system 110 operates with any sort of conventional processing hardware, including but not limited to, at least one processor 150, memory 152, an input/output device 154, an operating system 156, an application generator 158, and the common database 160. The input/output device 154 generally represents the interface(s) to networks (e.g., to the network 120, or any other local area, wide area or other network), mass storage, display devices, data entry devices and/or the like. The processor 150 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 152 represents any non-transitory short or long term storage or other computer-readable media capable of storing programming instructions for execution on the processor 150, including any sort of random access memory (RAM), read only memory (ROM), flash memory, magnetic or optical mass storage, and/or the like. The computer-executable programming instructions, when read and executed by the processor 150, cause the processor 150 to create, generate, or otherwise facilitate the virtual applications and perform one or more additional tasks, operations, functions, and/or processes described herein. It should be noted that the memory 152 represents one suitable implementation of such computer-readable media, and alternatively or additionally, the processor 150 could receive and cooperate with external computer-readable media that is realized as a portable or mobile component or application platform, e.g., a portable hard drive, a USB flash drive, an optical disc, or the like.

Still referring to FIG. 1, the data and services provided by the multi-tenant system 110 can be retrieved using any sort of personal computer, mobile telephone, tablet or other network-enabled client device 130 on the network 120. In an exemplary embodiment, the client device 130 includes a display device, such as a monitor, screen, or another conventional electronic display capable of graphically presenting data and/or information retrieved from the multi-tenant database 160. Typically, the user operates a conventional browser application (e.g., in the case of the client device 130 being a computer) or other client program such as an application (e.g., in the case of the client device 130 mobile telephone) executed by the client device 130 to contact the multi-tenant system 110 via the network 120 using a networking protocol, such as the hypertext transport protocol (HTTP) or the like. The user typically authenticates his or her identity to the multi-tenant system 110 to obtain a session identifier (“SessionID”) that identifies the user in subsequent communications with the multi-tenant system 110. When the identified user requests access to a virtual application, a runtime application generator 158 suitably creates the application at run time based upon the stored data, as appropriate. As noted above, the virtual application may contain Java, ActiveX, or other content that can be presented using conventional client software running on the client device 130; other embodiments may simply provide dynamic web or other content that can be presented and viewed by the user, as desired.

The multi-tenant database 160 is any sort of repository or other data storage system capable of storing and managing the data associated with any number of tenants. The database 160 may be implemented using any type of conventional database server hardware. In various embodiments, the database 160 shares processing hardware with the multi-tenant system 110. In other embodiments, the database 160 is implemented using separate physical and/or virtual database server hardware that communicates with the multi-tenant system 110 to perform the various functions described herein. In practice, the stored data may be organized and formatted in any manner to support the virtual applications. In various embodiments, the data is suitably organized into a relatively small number of large data tables to maintain a semi-amorphous “heap”-type format. The data can then be organized as needed for a particular virtual application. For example, conventional data relationships can be established using any number of pivot tables that establish indexing, uniqueness, relationships between entities, and/or other aspects of conventional database organization as desired. Further data manipulation and report formatting is generally performed at run-time using a variety of metadata constructs. Metadata within a universal data directory (UDD), for example, can be used to describe any number of forms, reports, workflows, user access privileges, business logic and other constructs that are common to multiple tenants. Tenant-specific formatting, functions and other constructs may be maintained as tenant-specific metadata for each tenant, as desired. Rather than forcing the data into an inflexible global structure that is common to all tenants and applications, the database 160 is organized to be relatively amorphous, with the pivot tables and the metadata providing additional structure on an as-needed basis. To that end, the application platform suitably uses the pivot tables and/or the metadata generate “virtual” components of the virtual applications to logically obtain, process, and present the relatively amorphous data from the database 160.

In various embodiments, the innovation management system 10 may be implemented on the multi-tenant system 110, for example, as a virtual application 180 and as a part of the database 160. In various embodiments, the innovation management system 10 manages the submittal and development of an initial idea by a user. In various embodiments, the innovation management system 10 manages the development of the initial idea into an innovation based on a defined process and available user talent. In various embodiments, the innovation management system 10 allows for the idea owner to lead the development of the idea through the defined process using various dynamic teams of user talent available from the multi-tenant system. In various embodiments, the innovation management system 10 manages the user talent of the multi-tenant system 110. In various embodiments, the innovation management system 10 performs these functions based on user input received via a user or other system interacting with a user interface 190, functions performed by an innovation management module 195, and data records stored in the database 160.

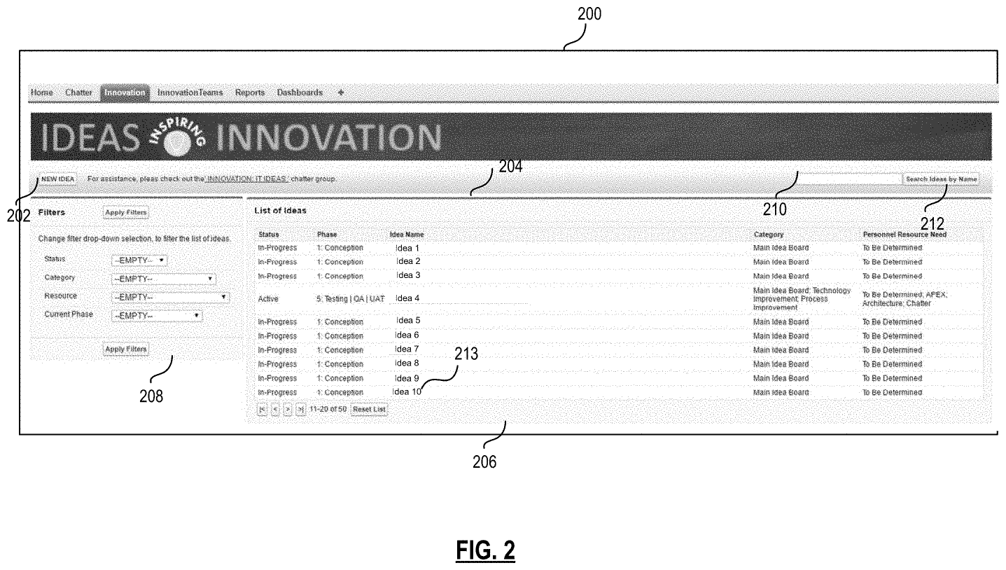

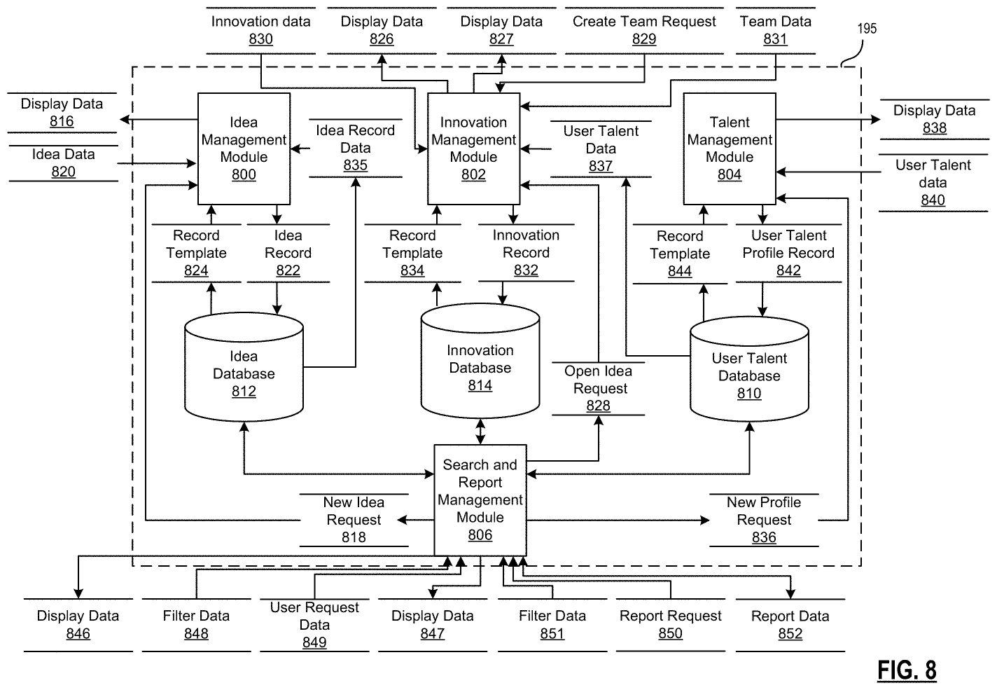

FIGS. 2-7 illustrate exemplary interfaces of the user interface 190 that may be implemented by the innovation management system 10; and FIG. 8 illustrates an exemplary innovation management module 195 that may be implemented by the innovation management system 10. As can be appreciated, any number of interfaces can be implemented to communicate information between the users and the innovation management module 195. While a certain number of interfaces having certain interface elements are depicted, it is appreciated that the functions and features described herein can be implemented using any number of interfaces and any combination of interactive interface elements including but not limited to text entry boxes, text display boxes, selection buttons, drop-down menus, tables, charts, lookup fields, etc.

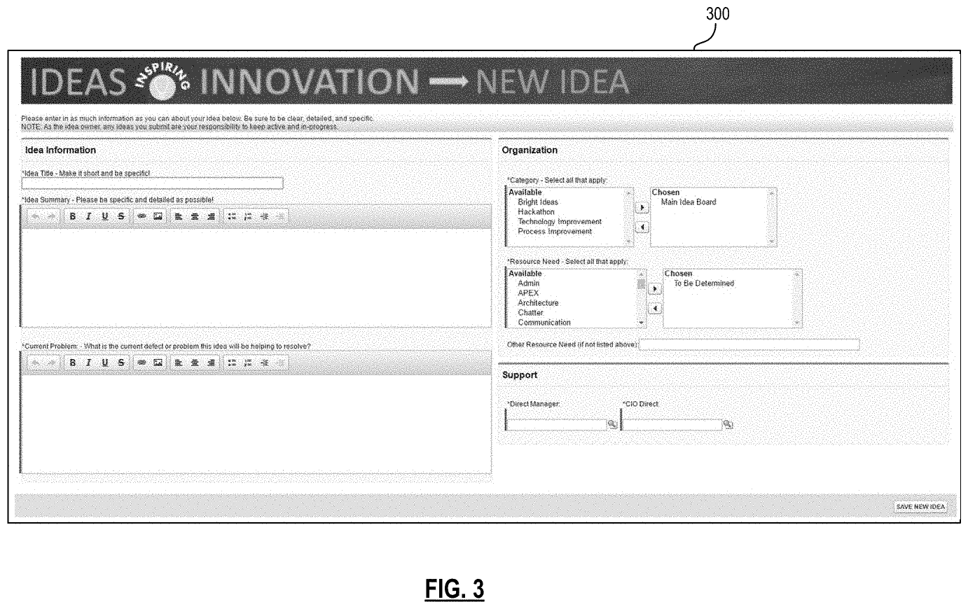

With reference now o FIG. 2, a first interface 200, referred to as a main page, is shown. The main page 200 includes interactive interface elements configured to enable functions such as, but not limited to, submitting a new idea, listing existing ideas, searching for ideas, and filtering the search for ideas. In various embodiments, at least one of the interactive elements of the main page includes a new idea selection box 202. Selection of the new idea selection box 202 activates the display of a second interface 300 shown in FIG. 3, referred to as the new idea page.

The new idea page 300 includes interactive interface elements configured to enable the entering of information related to a new idea. The information can include, but is not limited to, a title, a description of the idea, a description of the problem the idea solves, a category of the problem, any resources needed to implement the idea, and managerial support needed to implement the idea. As can be appreciated, other information can be entered in various embodiments.

With reference back to FIG. 2, at least one of the interactive interface elements of the main page 200 includes an interactive table 204 that includes a listings box 206 and a filters configuration box 208. In various embodiments, the listings box 206 is configured to list information about submitted ideas in a table format. The information can include, but is not limited to, a status, a phase, an idea, a category, and resources needed.

In various embodiments, the filters configuration box 208 is configured to include one or more drop-down menus for selecting filters. For example, when a menu item is selected, the list displayed in the chart is filtered based on the selected menu item. The drop-down menus can include, but are not limited to, a status menu, a category menu, a resource menu, and a current phase menu.

In various embodiments, the first interface 200 further includes a search by name text box 210 and a selection box 212 for searching a submitted idea by name. For example, when an idea title is entered in the text box 210 and the selection box 212 is selected, the list displayed in the chart is filtered based on the entered idea title.

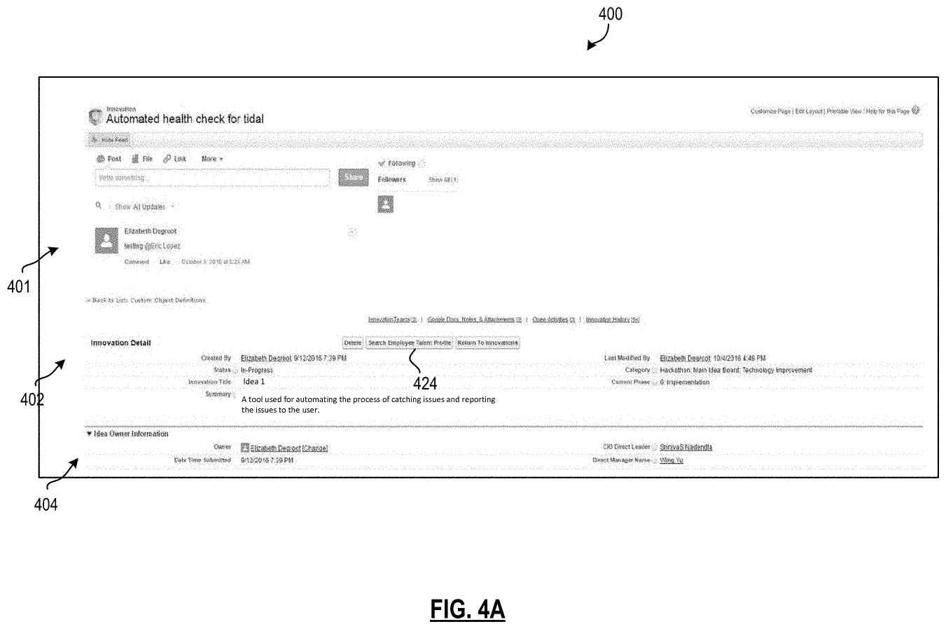

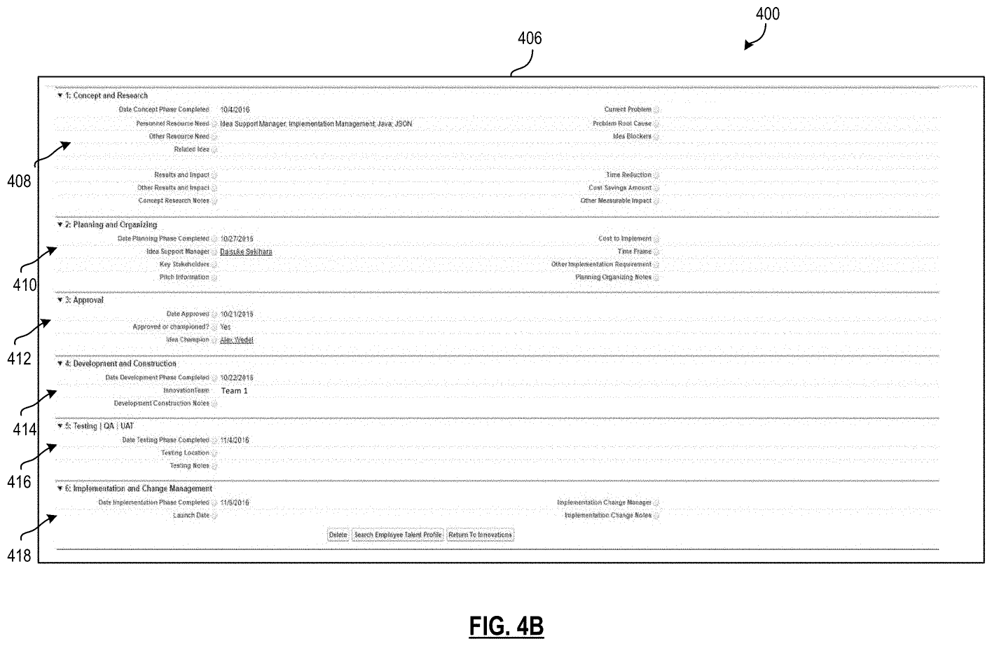

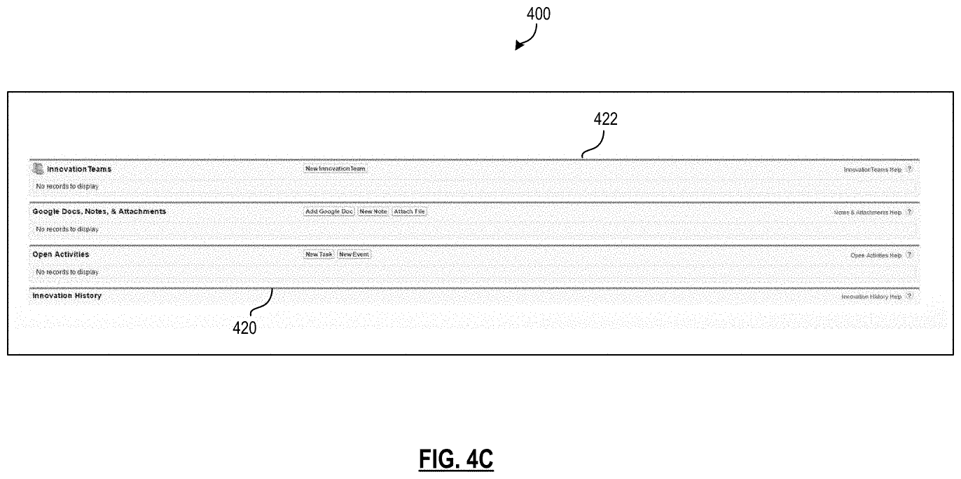

In various embodiments, each idea 213 of the displayed list is selectable. Selection of a listed idea 213 activates a third interface 400 shown in FIGS. 4A, 4B, and 4C, referred to collectively as the innovation page. The innovation page 400 includes a plurality of interactive boxes configured to accept information from the idea owner or other users, and display information to the owner and other users about the idea, the owner of the idea, and phases of development.

In various embodiments, the interactive boxes shown include a messaging box 401 (FIG. 4A), an idea details box 402 (FIG. 4A), an idea owner box 404 (FIG. 4A), and a phases box 406 (FIG. 4B). The messaging box 401 includes social messaging functions such as comment, like, and follow that can be associated with the submitted idea. The idea details box 402 displays information about the submitted idea. The information can include, but is not limited to, the creator, the status, the title of the idea, the short description of the idea, the category, the current phase, and the last user to modify. The idea owner box 404 displays information about the owner of the submitted idea. The information can include, but is not limited to, the owner name, the date and time the idea was submitted, and the direct leader name, and the manager name.

The phases box 406 displays information relating to each phase of a development process for the submitted idea. In various embodiments, the phases include a concept and research phase, a planning an organizing phase, an approval phase, a development and construction phase, a texting phase, and an implementation and change management phase. As can be appreciated, the development process can vary thus; the phases shown and described can vary for each idea or a group of ideas, in various embodiments.

As shown, each phase includes an interactive display sub-box. For example, a concept and research phase box 408 is configured to display and accept information about the concept and research phase of the defined process. The information can include, but is not limited to, a date the planning phase was completed, a list of resources needed for the phase, a list of related ideas, a current problem, a problem root cause, any idea blockers, results and impact, research notes, time reduction, cost savings amount and other measurable impacts.

In another example, a planning and organizing phase box 410 is configured to display and accept information about the planning and organizing phase of the defined process. The information can include, but is not limited to, a date the planning phase was completed, an idea support manager, key stakeholders, pitch information, cost to implement, time frame to implement, and other implementation requirements, and notes.

In another example, an approval phase box 412 is configured to accept and display information about the approval phase of the defined process. The information can include, but is not limited to, a date the approval phase was completed, an indication of approval, an idea champion.

In another example, a development and construction phase box 414 is configured to accept and display information about the development and construction phase of the defined process. The information can include, but is not limited to, a date the development phase was completed, a listing of development resources, and notes.

In another example, a testing phase box 416 is configured to accept and display information about the testing phase of the defined process. The information can include, but is not limited to, a date the testing phase was completed, a testing location, and notes related to testing.

In another example, an implementation and change management phase box 418 is configured to accept and display information about the implementation and change management phase of the defined process. The information can include, but is not limited to, a date the implementation phase was completed, a launch date, an implementation change manager, and notes.

In various embodiments, the innovation page 400 further includes a lists section 420 as shown in FIG. 4C that allows for the attachment of documents, and for tracking activities and user talent associated with each activity.

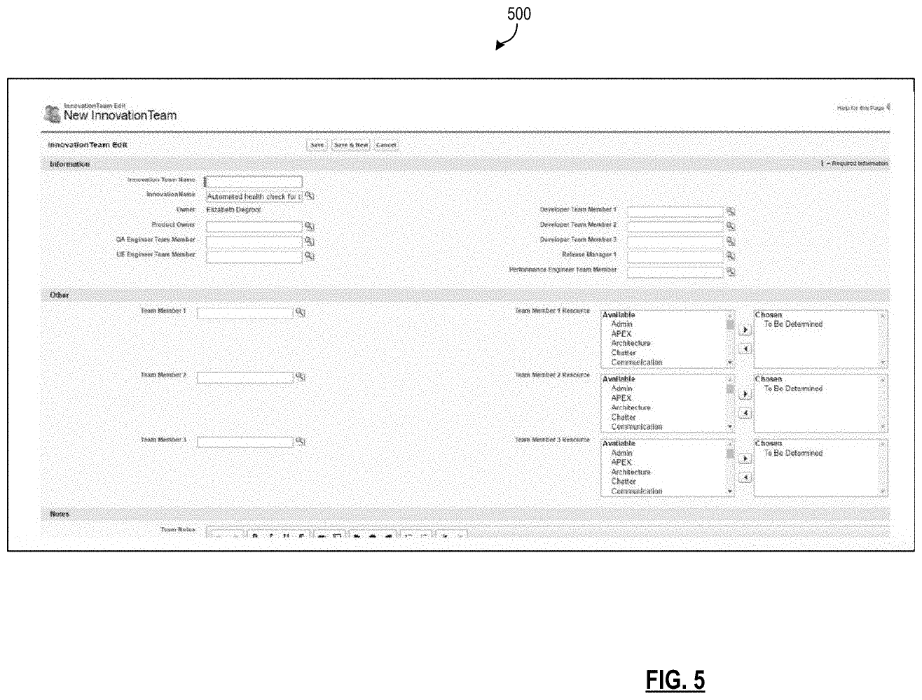

In various embodiments, the innovation page 400 further includes a new team selection box 422 for dynamically creating a team of user talent to work on the submitted idea. A team is typically comprised of the idea owner, and user talent selected by the idea owner (pending the user's approval). Selection of the new team selection box 422 activates a fourth interface 500 shown in FIG. 5, referred to as the new team page.

The new team page 500 includes a plurality of interactive interface elements configured to accept information from the idea owner or other users and display information to the owner and other users about a team of users. The information can include, but is not limited to, a team name, an idea name and owner, a product owner, a quality assurance engineer, any number of developers, a release manager, a performance engineer, and any number of specialists. In various embodiments, the fields of the new team innovation page can be lookup fields that access a database containing user talent profile records (as will be discussed in further detail below).

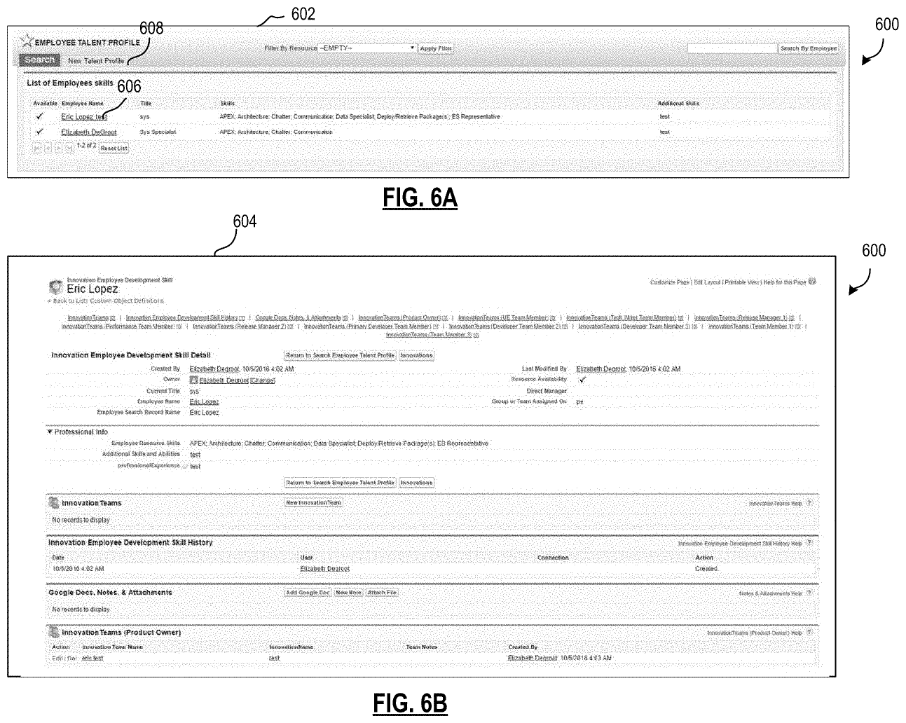

The user talent profile records can be created and found, for example, by way of a user talent profile selection box 424 on the innovation page 400. Selection of the user talent profile selection box 424 activates a fifth interface 600 shown in FIGS. 6A and 6B, referred to collectively as the user talent profile page. The user talent profile page 600 includes a listings box 602 (FIG. 6A) and a profile box 604 (FIG. 6B). The listings box 602 includes plurality of interactive elements configured to display a list of users, search the list of users, filter the search of users, and create a new user talent profile record. Upon selection of a user 606 listed in the list of users, the profile box 604 is populated with information associated with the selected user 606. The profile box 604 includes interactive elements configured to enable functions such as, but not limited to, listing user information, listing professional information, listing teams the user has participated on, listing development skill history, listing any documents associated with the user, and listing teams the user is the owner of the idea. The user information can include, for example, user title, name, search record name, availability, manager, group or team assigned. The professional information can include, for example, resource skills, experiences, other skills and abilities.

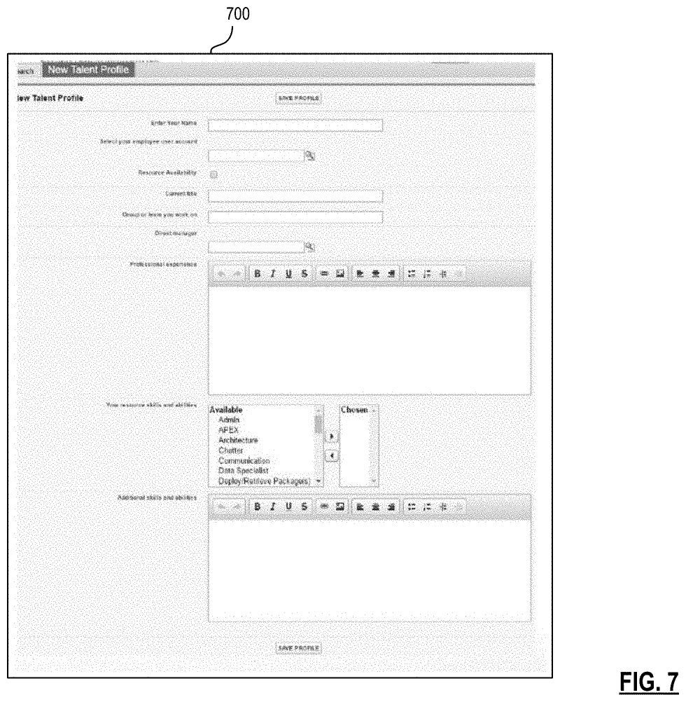

Upon selection of a selection interactive interface element for creating a new user talent profile record 608, a sixth interface 700 shown in FIG. 7 is activated. The sixth interface 700, referred to as the new user talent page, includes interactive elements configured to enable functions such as, but not limited to, entering user information and creating a new user talent profile record. The user information can include, for example, name, user account, availability, current use, group or team, direct manager, professional experience, resource skills and abilities, and any addition skills or abilities.

With reference now to FIG. 8 and with continued reference to FIGS. 1-7, a dataflow diagram depicts the innovation management module 195 in more detail in accordance with various embodiments. As can be appreciated, various exemplary embodiments of the innovation management system 10, according to the present disclosure, may include any number of modules and/or sub-modules. In various exemplary embodiments, the modules and sub-modules shown in FIG. 8 may be combined and/or further partitioned to similarly perform methods to manage the submittal of ideas and the development of those ideas into innovations using a team of user talent. In various embodiments, the innovation management system 10 includes an idea management module 800, an innovation management module 802, a talent management module 804, and a search and report management module 806. The modules 800-806 interact with the database 160 (FIG. 1) that includes a user talent database 810 an idea database 812, and an innovation database 814.

The idea management module 800 manages the submittal of new ideas via, for example, the second interface 300. For example, the idea management module 800 generates display data 816 for displaying the second interface 300 upon receipt of a request 818 to submit a new idea (e.g., based on a user's interaction with the first interface 200). The idea management module 800 receives idea data 820 generated based on a user's interaction with the second interface 300. In various embodiments, the idea data 820 includes title data, summary data, problem to be solved data, category of the idea data, resources needed data, and support needed data. Based on the idea data 820, the idea management module 800 generates an idea record 822 and stores the idea record 822 in the idea database 812.

In various embodiments, the idea management module 800 generates the idea record 822 based on a record template 824. The record template 824 includes fields for entry of each of the title data, summary data, problem to be solved data, category of the idea data, resources needed data, and support needed data. The idea management module 800 populates the fields of the record template 824 with the corresponding idea data 820 and stores the populated idea record template as the idea record 822. In various embodiments, the idea database 812 stores a plurality of record templates 824 that can be selected from, as the fields of the record template 824 can vary depending on the type of idea being submitted, the entity associated with the idea, the user submitting the idea, or other attributes associated with the idea.

The innovation management module 802 manages the development of the submitted ideas into innovations via, for example, the third interface 400. For example, the innovation management module 802 generates display data 826 for displaying the third interface 400, for example, upon receipt of a request 828 to open a listed idea (e.g., e.g., based on a user's interaction with the first interface 200). Initially, the third interface 400 is populated with idea record data 835 obtained from the idea database 812 and relating to the submitted idea. In response to displaying the third interface 400, the innovation management module 802 receives innovation data 830 generated based on a user's interaction with the third interface 400. In various embodiments, the innovation data 830 includes data corresponding to the phases of the defined process. In various embodiments, the innovation data 830 further includes additional documents, and tasks data. Based on the innovation data 830 and the idea record data 835, the innovation management module 802 generates an innovation record 832 and stores the innovation record 832 in the innovation database 814.

In various embodiments, the innovation management module 802 generates the innovation record 832 based on a record template 834. The record template 834 includes fields for entry of data into each of the phases. The innovation management module 802 populates the fields of the record template 834 with the corresponding innovation data 830 and stores the populated innovation record template as the innovation record 832. As the idea progresses through the predefined process, subsequent innovation data 830 is received. In such case, the innovation management module 802 retrieves the corresponding innovation record 832 from the innovation database 814 and generates display data 826 for displaying the third interface 400. As information associated with one of the phases is received, the innovation management module 802 updates the corresponding fields of the innovation record 832 with the innovation data 830 and stores the updated innovation record 832 in the innovation database 814.

The innovation management module 802 further manages the development of the submitted ideas into innovations by linking in user talent via, for example, the fourth interface 500. For example, the innovation management module 802 generates display data 827 for displaying the fourth interface 500, for example, upon receipt of a request 829 to create a team (e.g., e.g., based on a user's interaction with the third interface 400). In response to displaying the fourth interface 500, the innovation management module 802 receives team data 831 generated based on a user's interaction with the fourth interface 500 and links the innovation record 832 to user talent profile records 842 of the users indicated by team data 831. The user talent profile records 842 are stored in the user talent database 810 (as will be discussed in more detail below). The innovation management module 802 links the user talent profile records 842 by way of user talent data 837 indicating a location of the record in the user talent database 810. The user talent profile records 842 are linked to phases of the innovation record 832 based on designations provided in the team data 831.

The talent management module 804 manages user talent that may be used in submitting the ideas and supervising and developing the ideas into innovations via, for example, the sixth interface 700. For example, upon receiving a request 836 to create a new user talent profile (e.g., based on a user's interaction with the fifth interface 600), the talent management module 804 generates display data 838 for displaying the sixth interface 700. The talent management module 804 receives user talent data 840 generated based on a user's interaction with the sixth interface 700 and creates a user talent profile record 842 based on the user talent data 840. The talent management module 804 stores the user talent profile record 842 in the user talent database 810.

In various embodiments, the talent management module 804 generates the user talent profile record 842 based on a record template 844. The record template 844 includes fields for entry of each of name data, user account data, availability data, current use data, group or team data, direct manager data, professional experience data, resource skills and abilities data, and other additional skills or abilities data. The talent management module 804 populates the fields of the record template 844 with the corresponding user talent data 840 and stores the populated user talent profile record template as the user talent profile record 842.

In various embodiments, the search and report management module 806 manages the searching and display of submitted ideas, via, for example, the first interface 200. For example, the search and report management module 806 generates display data 846 for displaying the list of the first interface 200. In various embodiments, the search and report management module 806 generates initial search results based on default search parameters (e.g., no limitations and all ideas are shown). In various embodiments, the search and report management module 806 generates search results based on filter data 848 generated based on a user's interaction with the first interface 200. In various embodiments, the filter data 848 includes title data, status data, category data, resource data, and/or phase data. The search and report management module 806 searches the idea records 822 stored in the idea database 812 and/or the innovation records 832 stored in the innovation database 814 for fields satisfying the indicated parameters. The search and report management module 806 generates results and incorporates the results into the display data 846 for displaying results of the search via, for example, the first interface 200.

The search and report management module 806 generates the new idea request 818 based on user request data 849 indicating a request to submit a new idea.

In various embodiments, the search and report management module 806 manages the searching and display of user talent, via for example, the fifth interface 600. For example, the search and report management module 806 generates display data 847 for displaying the list of the fifth interface 600. In various embodiments, the search and report management module 806 generates initial search results based on default search parameters (e.g., no limitations and all ideas are shown). In various embodiments, the search and report management module 806 generates search results based on filter data 851 generated based on a user's interaction with the fifth interface 600. In various embodiments, the filter data 851 includes a resource type. The search and report management module 806 searches the user talent profile records 842 stored in the user talent database 810 for fields satisfying such parameters. The search and report management module 806 generates results and incorporates the results into the display data 847 for displaying the results via, for example, the fifth interface 600.

The search and report management module 806 generates the new profile request 836 based on the user request data 849 indicating a request for a new user talent profile.

In various embodiments, the search and report management module 806 processes data of the idea records 822, the innovation records 832, and/or the user talent profile records 842 and generates reports based thereon. For example, upon receiving a request 850 indicating a request for a report type and/or a type of information, the search and report management module 806 searches the records 822, 832, 842 for the requested type of information, process the results based on the requested report type, and generates report data 852 for displaying the report or communicating the report by email, text, or other communication means. As can be appreciated, the report type can be any type including, but not limited to, a table, a graph, etc. As can further be appreciated, the type of information can include any information available from the database 160 including, but not limited to, user talent information, idea information, innovation information, phase information, etc.

Disclosed herein are systems and methods for managing development of an idea into an innovation. In various embodiments, the management is based on user talent available by users of a multi-tenant system. In one embodiment, a computer implemented system for managing development of an idea into an innovation is provided. The system includes: a user talent database that stores a plurality user talent profile records relating to user talent; an idea database that stores a plurality of idea records relating to an idea submitted by a user; and an innovation database that stores an innovation record that that is based on a defined process. The system further includes an innovation management module configured to manage the development of the idea into an innovation by populating the innovation record with an idea record of the plurality of idea records, populating the innovation record with a dynamic subset of the plurality of user talent profile records, and populating the innovation record with data input by one or more users.

These aspects and other embodiments may include one or more of the following features. In various embodiments, the innovation record includes a concept and research phase, a planning and organizing phase, an approval phase, a development and construction phase, a testing phase, and an implementation and change management phase.

In various embodiments, a talent management module is configured to dynamically build a plurality of teams of user talent based on the plurality of user talent profile records and user input, wherein the subset of the plurality of user talent profile records includes a team of the plurality of teams.

In various embodiments, a reporting module is configured to process data stored within the innovation record to generate a report, wherein the report relates to user talent.

In various embodiments, a talent management module is configured to receive user input and populate a user talent profile record based on the user input.

In various embodiments, the user input includes name data, user account data, availability data, current use data, group or team data, direct manager data, professional experience data, resource skills and abilities data, and any addition skills or abilities data.

In various embodiments, a search management module is configured to search the plurality of user talent profile records and generate a listing of user talent.

In various embodiments, an idea management module is configured to receive user input and populate the idea record based on the user input.

In various embodiments, the user input includes title data, summary data, problem to be solved data, category of the idea data, resources needed data, and support needed data.

In various embodiments, a search management module is configured to search the plurality of idea records and generate a listing of ideas.

In yet another embodiments, a multi-tenant database system comprising one or more processors and non-transient computer readable media coupled to the one or more processors, the non-transient computer readable media embodying programming instructions configurable to perform a method is provided. The method includes: storing, in a user talent database, a plurality user talent profile records relating to user talent; storing, in an idea database, a plurality of idea records relating to an idea submitted by a user; storing, in an innovation database, an innovation record that that is based on a defined process; and managing the development of the idea into an innovation by populating the innovation record with an idea record of the plurality of idea records, populating the innovation record with a dynamic subset of the plurality of user talent profile records, and populating the innovation record with data input by one or more users.

In various embodiments, the innovation record includes a concept and research phase, a planning and organizing phase, an approval phase, a development and construction phase, a testing phase, and an implementation and change management phase.

In various embodiments, the method further comprises dynamically building a plurality of teams of user talent based on the plurality of user talent profile records and user input, wherein the subset of the plurality of user talent profile records includes a team of the plurality of teams.

In various embodiments, the method further comprises processing data stored within the innovation record to generate a report, wherein the report relates to user talent.

In various embodiments, the method further comprises receiving user input and populating a user talent profile record based on the user input.

In various embodiments, the user input includes name data, user account data, availability data, current use data, group or team data, direct manager data, professional experience data, resource skills and abilities data, and any addition skills or abilities data.

In various embodiments, the method further comprises searching the plurality of user talent profile records and generate a listing of user talent.

In various embodiments, the method further comprises receiving user input and populating the idea record based on the user input.

In various embodiments, the user input includes title data, summary data, problem to be solved data, category of the idea data, resources needed data, and support needed data.

In various embodiments, the method further comprises searching the plurality of idea records and generate a listing of ideas.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer implemented system for managing development of an idea into an innovation, the system comprising:
a user talent database that stores a plurality user talent profile records relating to user talent;
an idea database that stores a plurality of idea records relating to an idea submitted by a user;
an innovation database that stores an innovation record that that is based on a defined process; and
an innovation management module configured to manage the development of the idea into an innovation by populating the innovation record with an idea record of the plurality of idea records, populating the innovation record with a dynamic subset of the plurality of user talent profile records, and populating the innovation record with data input by one or more users.

2. The system of claim 1, wherein the innovation record includes a concept and research phase, a planning and organizing phase, an approval phase, a development and construction phase, a testing phase, and an implementation and change management phase.

3. The system of claim 1, further comprising talent management module configured to dynamically build a plurality of teams of user talent based on the plurality of user talent profile records and user input, wherein the subset of the plurality of user talent profile records includes a team of the plurality of teams.

4. The system of claim 1, further comprising a reporting module configured to process data stored within the innovation record to generate a report, wherein the report relates to user talent.

5. The system of claim 1, further comprising a talent management module configured to receive user input and populate a user talent profile record based on the user input.

6. The system of claim 5, wherein the user input includes name data, user account data, availability data, current use data, group or team data, direct manager data, professional experience data, resource skills and abilities data, and any addition skills or abilities data.

7. The system of claim 1, further comprising a search management module configured to search the plurality of user talent profile records and generate a listing of user talent.

8. The system of claim 1, further comprising an idea management module configured to receive user input and populate the idea record based on the user input.

9. The system of claim 8, wherein the user input includes title data, summary data, problem to be solved data, category of the idea data, resources needed data, and support needed data.

10. The system of claim 1, further comprising a search management module configured to search the plurality of idea records and generate a listing of ideas.

11. A multi-tenant database system comprising one or more processors and non-transient computer readable media coupled to the one or more processors, the non-transient computer readable media embodying programming instructions configurable to perform a method, the method comprising:
storing, in a user talent database, a plurality user talent profile records relating to user talent;
storing, in an idea database, a plurality of idea records relating to an idea submitted by a user;
storing, in an innovation database, an innovation record that that is based on a defined process; and
managing the development of the idea into an innovation by populating the innovation record with an idea record of the plurality of idea records, populating the innovation record with a dynamic subset of the plurality of user talent profile records, and populating the innovation record with data input by one or more users.

12. The system of claim 11, wherein the innovation record includes a concept and research phase, a planning and organizing phase, an approval phase, a development and construction phase, a testing phase, and an implementation and change management phase.

13. The system of claim 11, wherein the method further comprises dynamically building a plurality of teams of user talent based on the plurality of user talent profile records and user input, wherein the subset of the plurality of user talent profile records includes a team of the plurality of teams.

14. The system of claim 11, wherein the method further comprises processing data stored within the innovation record to generate a report, wherein the report relates to user talent.

15. The system of claim 11, wherein the method further comprises receiving user input and populating a user talent profile record based on the user input.

16. The system of claim 15, wherein the user input includes name data, user account data, availability data, current use data, group or team data, direct manager data, professional experience data, resource skills and abilities data, and any addition skills or abilities data.

17. The system of claim 11, wherein the method further comprises searching the plurality of user talent profile records and generate a listing of user talent.

18. The system of claim 11, wherein the method further comprises receiving user input and populating the idea record based on the user input.

19. The system of claim 18, wherein the user input includes title data, summary data, problem to be solved data, category of the idea data, resources needed data, and support needed data.

20. The system of claim 11, wherein the method further comprises searching the plurality of idea records and generate a listing of ideas.
